(19) United States
(12) Patent Application Publication
(10) Pub. No.: US 2026/0179973 A1
(43) Pub. Date: Jun. 25, 2026

(54) ELECTROCHEMICAL CELL STACK AND ELECTROCHEMICAL DEVICE

(71) Applicant: SAMSUNG ELECTRO-MECHANICS CO., LTD., Suwon-si (KR)

(72) Inventors: Dong In JEONG, Suwon-si (KR); Byung Chul JANG, Suwon-si (KR); Sun Il JEONG, Suwon-si (KR); Tae Jun CHOI, Suwon-si (KR); Hae Sol JUNG, Suwon-si (KR); Guh Hwan LIM, Suwon-si (KR)

(73) Assignee: SAMSUNG ELECTRO-MECHANICS CO., LTD., Suwon-si (KR)

(21) Appl. No.: 19/411,514

(22) Filed: Dec. 8, 2025

(30) Foreign Application Priority Data
Dec. 23, 2024 (KR) 10-2024-0194470

(51) Int. Cl. H01M 8/0228; C25B 9/19; C25B 13/02; C25B 13/05; H01M 8/0206; H01M 8/0232; H01M 8/0273; H01M 8/10; H01M 8/1004; H01M 8/1018

(52) U.S. Cl. CPC H01M 8/0228; C25B 9/19; C25B 13/02; C25B 13/05; H01M 8/0206; H01M 8/0232; H01M 8/0273; H01M 8/1004; H01M 8/1018; H01M 2008/1095

(57) ABSTRACT

An electrochemical cell stack includes first and second separators, an electrochemical cell disposed between the first and second separators, a first metal foam disposed between the first separator and the electrochemical cell, and a cell frame surrounding side surfaces of the first and second separators and the first metal foam.

### CROSS-REFERENCE TO RELATED APPLICATION(S)

This application claims benefit of priority to Korean Patent Application No. 10-2024-0194470 filed on Dec. 23, 2024 in the Korean Intellectual Property Office, the disclosure of which is incorporated herein by reference in its entirety.

### TECHNICAL FIELD

The present disclosure relates to an electrochemical cell stack and an electrochemical device.

Electrochemical devices include fuel cells generating electrical energy by electrochemically reacting fuel (hydrogen) with an oxidizer (pure oxygen or oxygen in the air), electrolysis cells generating hydrogen and oxygen through electrolysis of water, etc.

As examples of such electrochemical devices, polymer electrolyte membrane fuel cells (PEMFCs) and polymer electrolyte membrane water electrolysis cells (PEMECs) have come to prominence as eco-friendly energy source devices using hydrogen due to high efficiency and miniaturization. Polymer electrolyte membrane fuel cells and polymer electrolyte membrane water electrolysis cells generally include a membrane-electrode assembly (MEA) in which a polymer electrolyte membrane is disposed between catalyst electrodes. In addition, solid oxide fuel cells (SOFC) and solid oxide electrolysis cells (SOEC) include cells including an air electrode, a fuel electrode, and a solid electrolyte having oxygen ion conductivity, and here, the cells may be referred to as solid oxide cells. Solid oxide cells produce electrical energy through electrochemical reactions or produce hydrogen by electrolyzing water through a reverse reaction of solid oxide fuel cells. In addition, other types of fuel cells or electrolysis cells, such as phosphoric acid fuel cells (PAFCs), alkaline fuel cells (AFCs), and direct methanol fuel cells (DMFCs), have also been used as a type of electrochemical device.

In the case of electrochemical devices, it is common to use a stack structure in which unit cells are arranged between a pair of separators. In such a stack structure, excellent oxidation resistance and corrosion resistance may be required so that the electrochemical cell may be operated stably. In addition, fuel cells and electrolysis cells require a design of a stack structure taking into account fuel and fluid flow.

### SUMMARY

An aspect of the present disclosure is to provide an electrochemical cell stack and an electrochemical device with improved durability or the like.

According to an aspect of the present disclosure, an electrochemical cell stack may include: first and second separators; an electrochemical cell disposed between the first and second separators; a first metal foam disposed between the first separator and the electrochemical cell; and a cell frame surrounding side surfaces of the first and second separators and the first metal foam.

The first and second separators may not have a flow path.

The first and second separators may include Ti.

The electrochemical cell stack may further include: a protective layer applied to a surface of the first metal foam.

The first metal foam may include Ni, and the protective layer may include Pt.

The electrochemical cell stack may further include: a second metal foam disposed between the second separator and the electrochemical cell.

The cell frame may be formed of a plastic material.

The electrochemical cell stack may further include: a first gas diffusion layer disposed between the electrochemical cell and the first metal foam.

The electrochemical cell may include first and second catalyst electrodes and a polymer electrolyte membrane disposed between the first and second catalyst electrodes.

The cell frame may include first and second cell frames respectively surrounding side surfaces of the first and second catalyst electrodes.

The polymer electrolyte membrane may have a width wider than the cell frame.

According to another aspect of the present disclosure, an electrochemical device may include: a first end plate; a second end plate; and at least one electrochemical cell stack disposed between the first and second end plates, wherein the at least one electrochemical cell stack may include first and second separators, an electrochemical cell disposed between the first and second separators, a first metal foam disposed between the first separator and the electrochemical cell, and a cell frame surrounding side surfaces of the first and second separators and the first metal foam.

The electrochemical device may further include: a first current collecting layer disposed between the first end plate and the electrochemical cell stack; and a second current collecting layer disposed between the second end plate and the electrochemical cell stack.

The first and second current collecting layers may include protrusions protruding laterally as compared to the first and second end plates.

The cell frame may not surround side surfaces of the first and second current collecting layers.

The cell frame may not surround side surfaces of the first and second end plates.

### BRIEF DESCRIPTION OF DRAWINGS

The and other aspects, features, and advantages of the present disclosure will be more clearly understood from the following detailed description, taken in conjunction with the accompanying drawings, in which:

FIG. 1 is an exploded perspective view schematically illustrating an electrochemical cell stack according to an embodiment of the present disclosure;

FIG. 2 is a cross-sectional view of a region of an electrochemical cell stack;

FIG. 3 is a perspective view illustrating an example of a metal foam that may be used in an electrochemical cell stack;

FIG. 4 is a cross-sectional view illustrating an example of a metal foam that may be used in an electrochemical cell stack;

FIG. 5 is an enlarged cross-sectional view illustrating an example of an electrochemical cell;

FIG. 6 is a cross-sectional view illustrating another example of an electrochemical cell stack;

FIG. 7 is an exploded perspective view schematically illustrating an example of an electrochemical device; and

FIG. 8 is a cross-sectional view of a region of an electrochemical device.

### DETAILED DESCRIPTION

Hereinafter, some embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

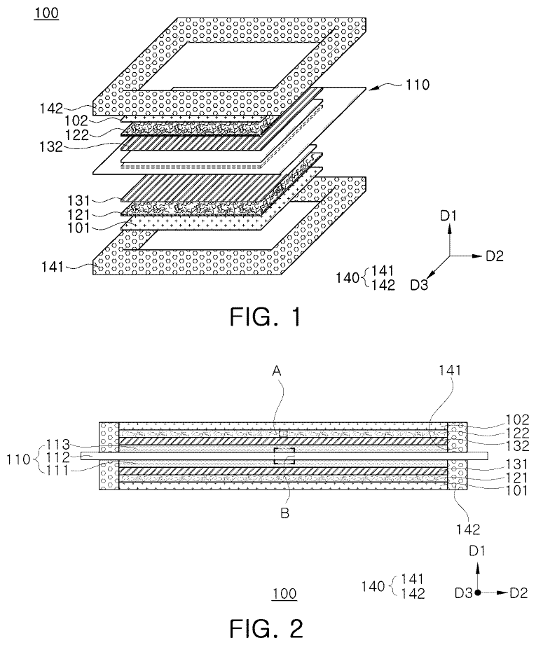

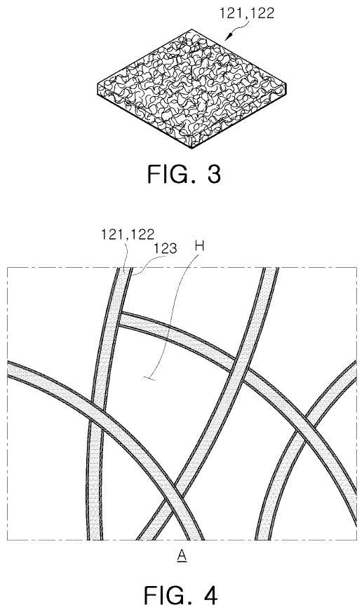

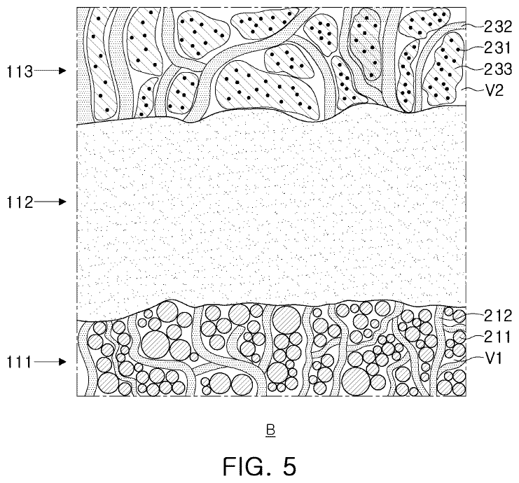

FIG. 1 is an exploded perspective view schematically illustrating an electrochemical cell stack according to an embodiment of the present disclosure. FIG. 2 is a cross-sectional view of a region of an electrochemical cell stack. FIGS. 3 and 4 are a perspective view and a cross-sectional view, respectively, illustrating an example of a metal foam that may be used in an electrochemical cell stack. FIG. 5 is an enlarged cross-sectional view illustrating an example of an electrochemical cell.

Referring to FIGS. 1 and 2, an electrochemical cell stack 100 according to an embodiment of the present disclosure may include, as major components, a first separator 101, a second separator 102, an electrochemical cell 110, a first metal foam 121, and a cell frame 140. The cell frame 140 may surround the side surfaces of the first and second separators 102 and the first metal foam 121. By employing the first metal foam 121, flow of a fluid may be ensured smoothly, while sufficiently securing electrical performance, and since the cell frame 140 may protect the separators 101 and 102 and the first metal foam 121, the durability of the electrochemical cell stack 100 may be improved. In addition, as illustrated, the electrochemical cell stack 100 may further include a second metal foam 122 disposed between the second separator 102 and the electrochemical cell 110 in addition to the first metal foam 121. A plurality of electrochemical cell stacks 100 may be stacked and used as an electrochemical device. Hereinafter, the components of the electrochemical cell stack 100 will be described.

The first separator 101 and the second separator 102 may be bipolar plates connecting electrochemical cells in series. The first separator 101 and the second separator 102 may include a metal having a high melting point and excellent corrosion resistance so as not to melt or soften at high temperatures when the electrochemical cell 110 is operated. For example, the first separator 101 and the second separator 102 may include Ti as an example of a material having excellent acid resistance, oxidation resistance, and withstand voltage characteristics. When the first separator 101 and the second separator 102 having excellent durability are used in PEMECs and PEMFCs, they may contribute to improving reliability. However, when the first and second separators 101 and 102 are implemented with a metal including Ti, the processability may be relatively poor, and especially, when forming a flow path, manufacturing costs of the first and second separators 101 and 102 may increase as the thickness increases. In addition, there is a possibility that the electrochemical cell, etc. may be deformed during a pressing process due to the flow path of the first and second separators 101 and 102.

In the present embodiment, by employing the first metal foam 121, the first and second separators 101 and 102 may be implemented thinly without a flow path, and thus the process efficiency and durability may be improved. Specifically, since a flow path function of the first separator 101 may be implemented by arranging the first metal foam 121 between the first separator 101 and the electrochemical cell 110, the first separator 101 may not have a flow path. Similarly, if the second metal foam 122 is present, the second separator 102 may not have a flow path. In this manner, the first and second separators 102 may be provided as flat plates without a flow path, and in this case, the first and second separators 102 may be formed thinly, so that the amount of raw material (e.g., Ti) used for making the first and second separators 102 is reduced, while contributing to miniaturization of the electrochemical cell stack 100. If the flow path of the type used in the related art separator is not used, the first and second separators 101 and 102 may be provided with one or more through-holes through which a fluid may move and come into contact with the electrochemical cell 110. In other words, the fact that the first and second separators 101 and 102 do not have a flow path means that there are no partitions or fluid passages formed along surfaces of the first and second separators 101 and 102, and there may be through-holes penetrating through the first and second separators 101 and 102.

A specific form of the metal foams 121 and 122 is described with reference to FIGS. 3 and 4 together. The description of the first metal foam 121 in the following description may also be applied to the second metal foam 122. As described above, the first metal foam 121 is disposed between the first separator 101 and the electrochemical cell 110. Accordingly, the first metal foam 121 may provide a flow path for electricity and fluid therebetween. For example, when the electrochemical cell stack 100 is used as a PEMEC, water may be supplied smoothly through the first metal foam 121. The first metal foam 121 may be a layer including, for example, a metal in a foamed structure, or a sponge structure in which metal wires are entangled, etc. As a more specific example, the first metal foam 121 may including a foamed structure including Ni (i.e., a Ni foamed structure). The first metal foam 121 may be an elastic member and may be compressed by the first separator 101 and the electrochemical cell 110. Since the first metal foam 121 includes pores H therein, the first separator 101 and the electrochemical cell 110 may be electrically connected without impeding the flow of fluid. A protective layer 123 may be applied on the surface of the first metal foam 121 to protect the first metal foam 121 by lowering the reactivity of the first metal foam 121 when the electrochemical cell 110 is driven. Considering this function, the protective layer 123 may include Pt. In particular, when the electrochemical cell stack 100 is used as a PEMEC, the components need to have high acid resistance and corrosion resistance due to an acidic environment. When the first metal foam 121 includes Ni, it is likely to be corroded in the acidic environment, and the durability of the first metal foam 121 may be improved through the protective layer 123 including Pt. The protective layer 123 including Pt or the like may be formed on the surface of the first metal foam 121 by using a method, such as depositing or plating a metal material on the surface of the first metal foam 121.

Similar to the first metal foam 121, the second metal foam 122 is disposed between the second separator 102 and the electrochemical cell 110 and may provide a flow path of electricity and fluid therebetween. The second metal foam 122 may be implemented as, for example, a foamed metal structure, a sponge structure in which metal wires are entangled, etc. As a more specific example, the second metal foam 122 may be implemented as a Ni foam including Ni. The second metal foam 122 may be an elastic member and may be compressed by the second separator 102 and the electrochemical cell 110. In addition, the protective layer 123 may be applied on the surface of the second metal foam 122 to protect the second metal foam 122 by lowering the reactivity of the second metal foam 122 when the electrochemical cell 110 is driven. Considering this function, the protective layer 123 may include Pt. In particular, when the electrochemical cell stack 100 is used as a PEMEC, the components need to have high acid resistance and corrosion resistance due to the acidic environment. If the second metal foam 122 includes Ni, it is likely to corrode in the acidic environment, and the durability of the first metal foam 121 may be improved through the protective layer 123 including Pt. The protective layer 123 including Pt or the like may be applied on the surface of the second metal foam 122 by using a method, such as depositing or plating a metal material on the surface of the second metal foam 122.

The electrochemical cell 110 may function as a fuel cell or a water electrolysis cell and may be, for example, a membrane-electrode assembly that may be used in PEMFCs and PEMECs. Hereinafter, the case in which the electrochemical cell 110 is a membrane-electrode assembly will be described, but the electrochemical cell 110 may also be another type of electrochemical cell, such as a solid oxide cell. Referring to FIG. 5, the electrochemical cell 110 may include a first catalyst electrode 111, a polymer electrolyte membrane 112, and a second catalyst electrode 113. and here, the polymer electrolyte membrane 112 may be disposed between the first and second catalyst electrodes 111 and 113. The first catalyst electrode 111 may include a first catalyst 211 and an aggregate of first catalyst 211 particles as illustrated in FIG. 5. In addition to the first catalyst 211, the first catalyst electrode 111 may include an ion conductor 212, and the ion conductor 212 may function as a binder of the first catalyst 211. In addition, pores V1 may be formed within the first catalyst electrode 111 so that gas, liquid, and the like may move smoothly. The first catalyst 211 may include an Ir-based, Ru-based, or Ti-based material active in an oxygen generation reaction. The ion conductor 212 may provide a movement path for hydrogen ions and the like generated by the first catalyst electrode 111 and may include, for example, a fluorinated ionomer, a carbon-hydrogen ionomer, and a mixture thereof. As a specific example, the ion conductor 212 may include a perfluorinated sulfonic acid ionomer. In the case of a water electrolysis cell, the first catalyst electrode 111 may be an anode, and water supplied thereto may be separated into oxygen O₂, hydrogen ions (H+, protons), and electrons. Here, the hydrogen ions may move to the second catalyst electrode 113 through the polymer electrolyte membrane 112, and the electrons may move to the second catalyst electrode 113 through an external circuit and a power supply. However, depending on the embodiment, the first catalyst electrode 111 may be a cathode electrode.

The polymer electrolyte membrane 112 may include an ion conductor to provide a movement path for hydrogen ions, etc. Here, the ion conductor of the polymer electrolyte membrane 112 may include, for example, a fluorinated ionomer, a carbon-hydrogen ionomer, and a mixture thereof. As a specific example, the ion conductor may include a perfluorinated sulfonic acid ionomer. In the case of a water electrolysis cell, hydrogen ions generated in the first catalyst electrode 111 may move to the second catalyst electrode 113 through the polymer electrolyte membrane 112.

The second catalyst electrode 113 may include a second catalyst 231 and may be disposed on the polymer electrolyte membrane 112. In this case, as illustrated in FIG. 5, the second catalyst 231 may be provided in a form supported by a support 233. In addition, the second catalyst electrode 113 may include an ion conductor 232, and the ion conductor 232 may function as a binder for the second catalyst 231 and the support 233. In addition, pores V2 may be formed within the second catalyst electrode 113 so that gas, liquid, or the like may move smoothly. The second catalyst 231 may be active in a hydrogen oxidation reaction or an oxygen reduction reaction and may include at least one selected from the group consisting of platinum (Pt), gold (Au), ruthenium (Ru), osmium (Os), palladium (Pd), and alloys thereof. The ion conductor 232 may provide a movement path for hydrogen ions, etc., and may include, for example, a fluorinated ionomer, a carbon-hydrogen ionomer, and a mixture thereof. As a specific example, the ion conductor 232 may include a perfluorinated sulfonic acid ionomer. The support 233 may be formed as a porous body having a high surface area so as to be able to support a large amount of the second catalyst 231, and, for example, a carbon-based support may be used. In the case of a water electrolysis cell, the second catalyst electrode 113 may be a cathode, and hydrogen ions supplied through the polymer electrolyte membrane 112 may react with electrons to generate hydrogen. However, depending on the embodiment, the second catalyst electrode 113 may be an anode electrode.

The cell frame 140 may support the entire electrochemical cell stack 100 by surrounding the side surfaces of the first and second separators 102 and the first metal foam 121 and may also perform a function of sealing the fluid. In this case, the cell frame 140 may surround the side surfaces of the second metal foam 122 in addition to the first metal foam 121. When the electrochemical cell stack 100 is utilized as a PEMEC or PEMFC, the cell frame 140 may be formed of a plastic material because it may be operated at a relatively low temperature. The cell frame 140 formed of a plastic material may have high sealing performance and support performance.

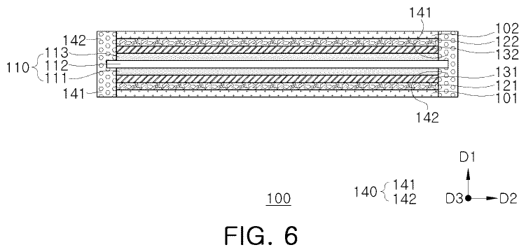

As described above, the cell frame 140 may surround and protect the side surfaces of the first and second separators 102, the electrochemical cell 110, and the first and second metal foams 121 and 122. In this case, the cell frame 140 may include first and second cell frames 141 and 142 surrounding the side surfaces of the first and second catalyst electrodes 111 and 113 of the electrochemical cell 110, respectively. In this case, the first and second cell frames 141 and 142 may be separated from each other by the polymer electrolyte membrane 112 of the electrochemical cell 110. To this end, the polymer electrolyte membrane 112 may be wider than the cell frame 140. However, in addition to this form, as in the embodiment of FIG. 6, the polymer electrolyte membrane 112 may be narrower than the cell frame 140, and in this case, the first and second cell frames 141 and 142 may be connected to each other to form an integral structure.

Referring back to FIG. 2, components that may be added to the electrochemical cell stack 100 are described. A first gas diffusion layer 131 may be disposed between the electrochemical cell 110 and the first metal foam 121. Similarly, a second gas diffusion layer 132 may be disposed between the electrochemical cell 110 and the second metal foam 122. The first gas diffusion layer 131 and the second gas diffusion layer 132 may play a role of uniform material transfer and may be implemented as a porous structure including a metal. For example, the first gas diffusion layer 131 and the second gas diffusion layer 132 may include fibers or sintered bodies including materials, such as Ni, Ti, and C. As a more specific example, among the first gas diffusion layer 131 and the second gas diffusion layer 132, the anode electrode of a water electrolysis cell may include Ti, and the cathode electrode may include C.

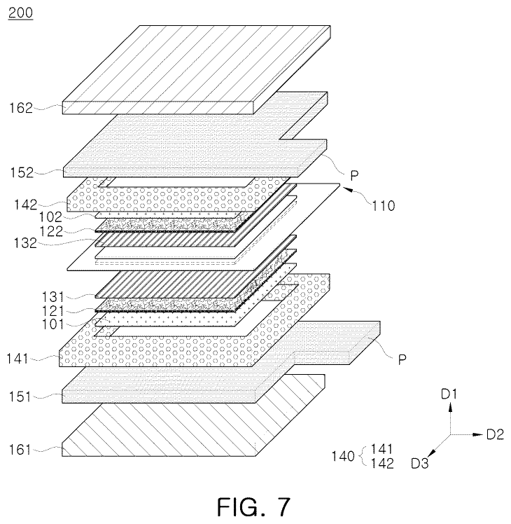

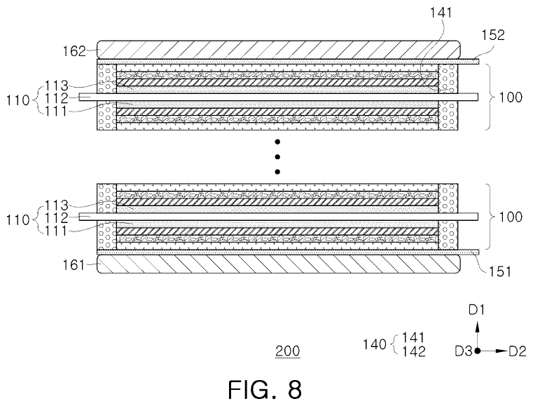

An example of an electrochemical device is described with reference to FIGS. 7 and 8. An electrochemical device 200 may include a first end plate 161 and a second end plate 162, and the electrochemical cell stack 100 having the structure described above is disposed therebetween. At least one electrochemical cell stack 100 may be provided, and when the electrochemical cell stack 100 is provided in plural, the plurality of electrochemical cell stacks 100 may be stacked in a direction in which the first and second end plates 161 and 162 face each other.

The first and second end plates 161 and 162 are arranged on the outermost side of the electrochemical device 200 and may be provided in the form of metal plates having high durability and heat dissipation performance. As a specific example, the first and second end plates 161 and 162 may be formed of a metal, such as stainless steel, nickel, iron, or copper. A first current collecting layer 151 may be disposed between the first end plate 161 and the electrochemical cell stack 100, and similarly, a second current collecting layer 152 may be disposed between the second end plate 162 and the electrochemical cell stack 100. As illustrated, the first and second current collecting layers 151 and 152 may include a protrusion P protruding laterally as compared to the first and second end plates 161 and 162 and may be connected to an external power source through the protrusion P. Meanwhile, in the electrochemical device 200, the cell frame 140 may not surround the side surfaces of the first and second current collecting layers 151 and 152. In addition, the cell frame 140 may not surround the side surfaces of the first and second end plates 161 and 162.

In the case of the electrochemical cell stack according to an example of the present disclosure, durability may be improved. Therefore, when such an electrochemical cell stack is applied to an electrochemical device, such as a fuel cell or a water electrolysis cell, performance may be improved.

While embodiments have been illustrated and described above, it will be apparent to those skilled in the art that modifications and variations could be made without departing from the scope of the present disclosure as defined by the appended claims.

What is claimed is:

1. An electrochemical cell stack comprising:
first and second separators;
an electrochemical cell disposed between the first and second separators;
a first metal foam disposed between the first separator and the electrochemical cell; and
a cell frame surrounding side surfaces of the first and second separators and the first metal foam.

2. The electrochemical cell stack of claim 1, wherein the first and second separators do not have a flow path.

3. The electrochemical cell stack of claim 1, wherein the first and second separators include Ti.

4. The electrochemical cell stack of claim 1, further comprising a protective layer disposed on a surface of the first metal foam.

5. The electrochemical cell stack of claim 4, wherein the first metal foam includes Ni, and the protective layer includes Pt.

6. The electrochemical cell stack of claim 1, further comprising a second metal foam disposed between the second separator and the electrochemical cell.

7. The electrochemical cell stack of claim 1, wherein the cell frame includes a plastic material.

8. The electrochemical cell stack of claim 1, further comprising a first gas diffusion layer disposed between the electrochemical cell and the first metal foam.

9. The electrochemical cell stack of claim 1, wherein the electrochemical cell includes first and second catalyst electrodes and a polymer electrolyte membrane disposed between the first and second catalyst electrodes.

10. The electrochemical cell stack of claim 9, wherein the cell frame includes first and second cell frames respectively surrounding side surfaces of the first and second catalyst electrodes.

11. The electrochemical cell stack of claim 9, wherein the polymer electrolyte membrane has a width wider than the cell frame.

12. An electrochemical device comprising:
a first end plate;
a second end plate; and
at least one electrochemical cell stack disposed between the first and second end plates,
wherein the at least one electrochemical cell stack includes first and second separators, an electrochemical cell disposed between the first and second separators, a first metal foam disposed between the first separator and the electrochemical cell, and a cell frame surrounding side surfaces of the first and second separators and the first metal foam.

13. The electrochemical device of claim 12, further comprising:
a first current collecting layer disposed between the first end plate and the electrochemical cell stack; and
a second current collecting layer disposed between the second end plate and the electrochemical cell stack.

14. The electrochemical device of claim 13, wherein the first and second current collecting layers include protrusions protruding laterally as compared to the first and second end plates.

15. The electrochemical device of claim 13, wherein the cell frame does not surround side surfaces of the first and second current collecting layers.

16. The electrochemical device of claim 13, wherein the cell frame does not surround side surfaces of the first and second end plates.

17. The electrochemical cell stack of claim 1, wherein the first and second separators include through-holes penetrating through the first and second separators.
